(19) United States
(12) Patent Application Publication
(10) Pub. No.: US 2016/0259289 A1
(43) Pub. Date: Sep. 8, 2016

(54) METHOD AND DEVICE FOR ADAPTATION OF A COATING SUBSTANCE IN A PRINTING SYSTEM

(71) Applicant: Oce Printing Systems GmbH & Co. KG, Poing (DE)

(72) Inventors: Sabine Gerlach, Muenchen (DE); Thomas Montag, Unterhaching (DE)

(73) Assignee: Oce Printing Systems GmbH & Co. KG, Poing (DE)

(21) Appl. No.: 15/060,893

(22) Filed: Mar. 4, 2016

(30) Foreign Application Priority Data
Mar. 4, 2015 (DE) 102015103100.0

(51) Int. Cl. G03G 15/00

(52) U.S. Cl. CPC G03G 15/6582

(57) ABSTRACT

Printing systems and methods for conditioning a recording medium are described. For example, to condition the recording medium, a property of a coating substance to be applied to the recording medium, such as the composition of the coating substance can be adjusted. Further, the quantity of the coating substance to be applied to the recording medium can be adjusted. The quality of a printed image created by the printing system can be improved by adjusting the property and/or the quantity of the coating substance.

### CROSS REFERENCE TO RELATED APPLICATIONS

This patent application claims the benefit of German Patent Application No. 102015103100.0, filed Mar. 4, 2015, which is incorporated herein by reference in its entirety.

### BACKGROUND

Embodiments described herein generally relate to printing systems, including liquid toner printing systems, and methods and devices for adaptation of a coating substance used in printing system to increase the print quality of print images.

A printing system may comprise a conditioning group which pre-treats with a coating substance a recording medium to be printed to by said printing system. For example, the adhesion of toner particles on the surface of the recording medium may be increased via the pre-treatment with a coating substance. Examples of coating substances are described in WO2013/126869A1.

The print results achieved via the printing system may depend on the properties of the coating substance that is used. Furthermore, different types of recording media for the most part require different coating substances, or coating substances with different properties.

An object of the present disclosure is to adapt the pre-treatment of the recording medium with a coating substance automatically and efficiently in order to increase the achieved print quality.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a view of a printing system using an example of a roll-to-roll configuration of a digital printer according to an exemplary embodiment of the present disclosure.

FIG. 2 illustrates an example of a device for adaptation of the properties and/or of the quantity of a coating substance according to an exemplary embodiment of the present disclosure.

FIG. 3 illustrates a workflow diagram of an example of a method for adaptation of the properties and/or of the quantity of a coating substance according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

According to one aspect, a printing system is described. The printing system comprises a conditioning group that is configured to apply a coating substance onto a recording medium, and thus to provide a pre-treated recording medium. Furthermore, the printing system comprises at least one print group that is configured to print a first print image on the pre-treated recording medium. Moreover, the printing system comprises a print image sensor that is configured to detect print image data, wherein the print image data indicate information with regard to the first print image. Furthermore, the printing system comprises a controller that is configured to determine—on the basis of the print image data—a property and/or a quantity of the coating substance to be applied by the conditioning group. The controller is furthermore configured to induce the conditioning group to correspondingly adapt the property and/or the quantity of the coating substance that is to be applied onto the recording medium for the printing of a second print image, wherein the second print image follows after the first print image, or wherein the second print image is printed after the first print image.

According to a further aspect, a method is described for regulation of a property and/or a quantity of a coating substance during the operation of a printing system. The method includes the application of a coating substance onto a recording medium in order to provide a pre-treated recording medium. Moreover, the method includes the printing of a first print image onto the pre-treated recording medium via the printing system. Furthermore, the method includes the detection of print image data, wherein the print image data indicate information with regard to the first print image. Moreover, the method includes the adaptation—on the basis of the print image data—of a property and/or of a quantity of the coating substance to be applied onto the recording medium for the printing of a second print image, wherein the second print image follows after the first print image.

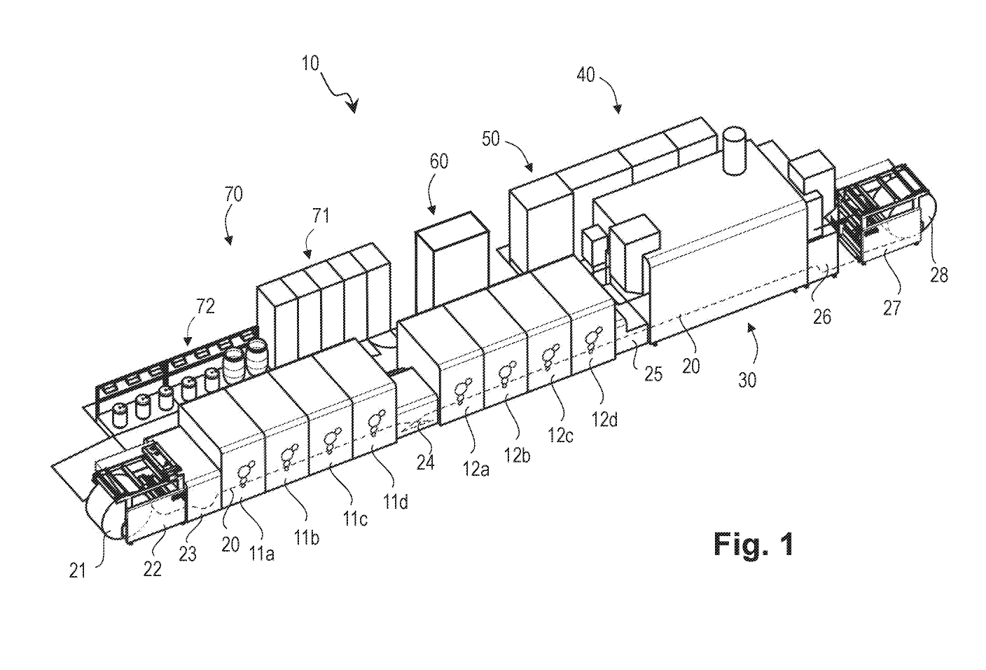

According to FIG. 1, a digital printer 10 for printing to a recording medium 20 has one or more print groups 11a-11d and 12a-12d that print a toner-based print image onto the recording medium 20. As shown, a web-shaped recording medium 20 as a recording medium 20 is unspooled from a roll 21 with the aid of a take-off unit 22 and is supplied to the first print group 11a. The print image 20′ is fixed on the recording medium 20 in a fixing unit 30. The recording medium 20 may subsequently be taken up on a roll 28 with the aid of a take-up unit 27. A configuration depicted in FIG. 1 is also designated as a roll-to-roll printing system. Alternatively, the recording medium 20 may be divided up into individual sheets by a cutter or sheet cutter (not shown) at the output of the fixing unit 30.

FIG. 1 depicts a digital printer 10 based on the electrophotographic principle according to an exemplary embodiment. It is noted that the aspects described in this document are also applicable to other types of digital printers 10 (for example other types of toner printers, ink printers, as well as to offset printers).

In the configuration shown in FIG. 1, the web-shaped recording medium 20 is printed to in full color on the front side with four print groups 11a through 11d and on the back side with four print groups 12a through 12d (what is known as a 4/4 configuration). For this, the recording medium 20 is unwound from the roll 21 by the take-off unit 22 and supplied to the first print group 11 a via a conditioning group 23. Other configurations of print groups 11, 12 are also conceivable, in particular a 7/0 configuration with 7 print groups 11 for the front side and no print group 12 for the back side. In the conditioning group 23, the recording medium 20 is pre-treated or coated with a suitable substance. For example, aqueous polymer emulsions may be used as a coating substance (also designated as a primer).

The recording medium 20 is subsequently supplied first, in order, to the first print groups 11a through 11d in which only the front side is printed to. Each print group 11a-11d typically prints to the recording medium 20 in a different color or also with different toner material, for example MICR (Magnetic Ink Character Recognition) toner which can be read electromagnetically.

After printing to the front side, the recording medium 20 may be turned in a turning unit 24 and be supplied to additional print groups 12a-12d for printing to the back side. In the region of the turning unit 24, an additional conditioning group (not shown in FIG. 1) may be arranged via which the recording medium 20 is prepared for the printing to the back side. It is thus prevented that the front-side print image is mechanically damaged upon further transport through the subsequent print groups.

Typically arranged after the print group 12d is a register unit 25 via which registration marks—which are printed on the recording medium 20 independently of the print image 20′ (in particular outside of the print image 20′)—are evaluated. The transversal and longitudinal registration (the primary color dots that form a color point should be arranged atop one another or spatially very close to one another; this is also designated as color registration or four-color registration) and the register (front side and back side must spatially coincide precisely) can therefore be adjusted so that a qualitatively good print image 20′ is achieved.

Arranged after the register unit 25 is the fixing unit 30 via which the print image 20′ is fixed on the recording medium 20. Arranged after the fixing unit 30 is a pulling unit 26 that pulls the recording medium 20 through all print groups 11a-12d and the fixing unit 30 without an additional drive being arranged in this region. The danger that the as of yet unfixed print image 20′ could be smeared would exist due to a friction drive for the recording medium 20.

The pulling unit 26 feeds the recording medium 20 to the take-up unit 27, which rolls up the printed recording medium 20. Alternatively, the recording medium 20 may be cut into individual printed sheets via a sheet cutter.

Centrally arranged in the print groups 11, 12 and the fixing unit 30 are all supply devices for the digital printer 10, such as air-conditioning modules 40, power supply 50, controller 60, fluid management modules 70 (such as fluid controller 71 and reservoirs 72 of the different fluids). In particular, pure carrier fluid, highly-concentrated liquid developer (high proportion of toner particles in relation to carrier fluid) and serum (carrier fluid plus charge control substances) are required as fluids in order to supply the digital printer 10, as well as waste containers for fluids to be disposed of or containers for cleaning fluid.

The recording medium 20 may be manufactured from paper, paperboard, cardboard, metal, plastic and/or other suitable and printable materials.

As clarified in FIG. 1, the number of print groups 11 of the printing system 10 may vary. The quantity of carrier fluid and/or of cleaning fluid that a recording medium 20 is exposed to upon printing a print image thereby also vary. In order to achieve a uniformly high print quality for these different conditions, it may be necessary to adapt the quantity and/or the composition of primer or coating substance which is applied onto the recording medium 20 in the conditioning group 23 to the different conditions. Typically not only the applied quantity of coating substance but also the composition of the coating substance—for example a water proportion (carrier material), a solid proportion (active substance) and possibly a proportion of additional additive substances—is thereby significant. The composition of the coating substance may also be considered as a property of the coating substance.

Moreover, different recording media 20 with different properties—for example with different absorption capability—for the most part require an adaptation of the quantity and/or the composition of the applied coating substance. Moreover, the required quantity and/or composition of the coating substance may vary due to production fluctuations in the production of the recording medium 20. Further factors additionally come into consideration which alter the recording medium 20 and, as a result, require an adaptation of the quantity and/or the composition of the coating substance. For example, these factors may include differences in the humidity and/or temperature in the print room or given storage of the recording medium 20.

The print groups 11 may be configured to adapt one or more printing conditions upon application of the print image onto the recording medium 20 in order to achieve an optimally high print image quality. For example, as one printing condition the quantity of carrier fluid in the liquid developer may be adapted at various points in the printing process.

Furthermore, the conditioning group 23 may be configured to adapt the pre-treatment of the recording medium 20 with a coating substance in order to achieve an optimally high print image quality. In particular, via an adaptation of the quantity and/or the composition of the coating substance it may be achieved that print quality artifacts—for example mottling, return transfer of the toner and/or a print image wicking—are avoided. For example, the conditioning group 23 may be adapted given a standstill of the printing system 10. For example, a raster (e.g. anilox) roller of the conditioning group 23 may thereby be exchanged and/or the composition of the coating substance that is used may be modified. Such adaptations of the conditioning group 23 are linked with an installation cost and elaborate exchange routines. Furthermore, the quantity and/or the composition of the coating substance cannot be corrected in a production run.

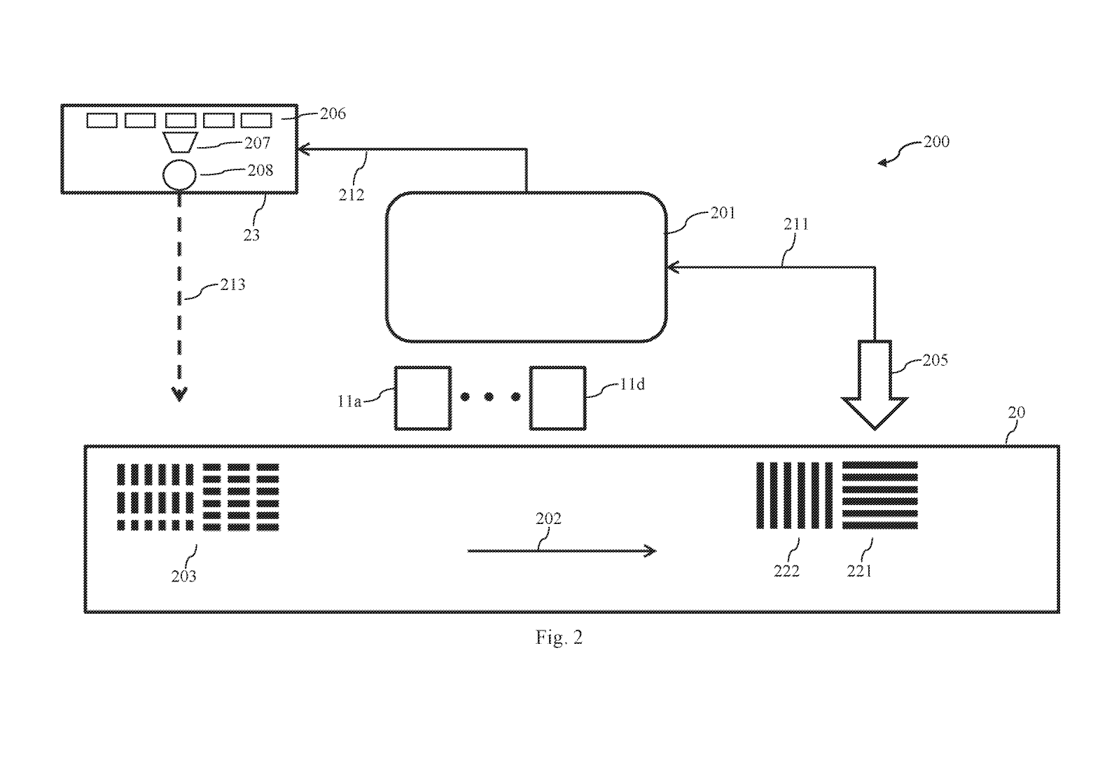

FIG. 2 illustrates a device 200 according to an exemplary embodiment of the present disclosure. The device 200 can be configured to adapt the pre-treatment of the recording medium 20 with a coating substance 213 automatically in order to increase a quality of the created print image. In an exemplary embodiment, the device 200 includes a controller 201 that is configured to receive print image data 211 from a print image sensor 205. In particular, the controller 201 is configured to determine the value of a pitch measure and/or of a control fault on the basis of the print image data 211, where the pitch measure or control fault indicates a deviation of the quality of the created print image from a nominal print image. In an exemplary embodiment, the controller 201 includes processor circuitry configured to perform one or more of the operations performed (and/or functions of) the controller 201, including (but not limited to), for example, receiving print image data 211 and/or determining the value of a pitch measure and/or of a control fault on the basis of the print image data 211.

The print image data 211 include information with regard to the actual printed print image. The print image data 211 may be compared with a nominal print image in order to determine a value of the pitch measure or of the control fault. In an exemplary embodiment, a pitch measure is the Delta E value. The Delta E value may be determined as a Euclidean distance between two color values (for example a first color value for the actual printed print image and a second color value for a nominal print image) (see ISO 12647 and ISO 13655).

In an exemplary embodiment, the controller 201 is configured to determine and/or generate a control signal 212 to control the conditioning group 23. The control signal 212 may be generated based on the print image data. In particular, the control signal 212 may be determined such that, via the control signal 212, the conditioning group 23 is adapted such that the value of the pitch measure or of the control fault is reduced. For this purpose, the controller 201 may access a predefined model of a controlled system of the printing system 10 between conditioning group 23 and print image sensor 205. The controlled system thereby in particular comprises the conditioning group 23 and the one or more print groups 11a, . . . , 11d of the printing system 10.

In an exemplary embodiment, the conditioning group 23 is configured to adapt a property and/or a quantity of the coating substance 213 applied onto the recording medium 20 depending on the control signal 212. The property of the coating substance 213 in particular encompasses a composition of the coating substance 213. The composition may thereby be modified with regard to, for example (but is not limited to):

the type of active substance that is used;

the type of active substance carrier fluid;

the type of one or more additive substances; and/or

the ratio of active substance, active substance carrier fluid and/or additive substances in the coating substance 213.

In an exemplary embodiment, the quantity of the coating substance 213 may correspond to an absolute quantity of the coating substance 213 (per area unit) given a solid composition of the coating substance 213.

For example, the conditioning group 23 may comprise a plurality of containers 206 for a plurality of coating substances 213 with different properties. Depending on the control signal 212, the conditioning group 23 may select one or more of the containers 206 in order to create an adapted coating substance 213. Furthermore, the conditioning group 23 may comprise one or more mixers 207 in order to mix the coating substance 213 to be applied from the substances of the selected containers 206. Moreover, the conditioning group 23 may comprise a raster roller 208 via which the coating substance 213 may be brought to the recording medium 20. A rotation speed of the raster roller 208 may be adapted in order to adapt the quantity of the applied coating substance 213.

In an exemplary embodiment, the controller 201 can be configured to make a suitable pre-selection for the coating substance 213 that is used given specification of a type of recording medium 20 that is used. For example, the controller 201 may thereby access predefined configuration data that specify the default properties of the coating substance 213 that are to be used for a specific type of recording medium 20. In particular, a default composition and/or quantity of the coating substance 213 that are to be used may be specified. The conditioning group 23 may then be instructed (or adapted accordingly) in order to provide a coating substance 213 in this composition and/or with this quantity. Given selection of a specific type of recording medium 20 in the printer control panel of the printing system 10, a specific quantity and/or composition of the coating substance 213 may thus be requested by the controller 201 and be mixed and provided by the conditioning group 23.

In an exemplary embodiment, the controller 201 may be configured to adapt—via evaluation of the print image data 211 during the printing process—the composition and/or quantity of the coating substance 213 in order to counteract variations of the recording medium 20 and in order to keep the print image quality stable.

In an exemplary embodiment, to adapt the properties (in particular the composition) and/or quantity of the coating substance 213, the printing system 10 may be configured to print one or more predefined printing marks 221, 222 (also designated as toner marks) onto the recording medium 20. FIG. 2 shows examples of printing marks 221, 222 which respectively comprise a plurality of bars or, respectively, stripes that are arranged transversal to and/or in the transport direction 202 of the recording medium 20. The conditioning group 23 applies coating substance 213 onto the recording medium 20 in a region 203 of the surface of the recording medium 20 in which the printing marks 221, 222 are printed by the subsequent one or more print groups 11a, . . . , 11d (the region 203 is illustrated by the dashed printing marks in FIG. 2).

The print image data 211 may include information with regard to the actual printed one or more printing marks 221, 222. These print image data 211 may be evaluated by the controller 201 in order to determine the control signal 212. In particular, an inking difference between the two printing marks 221, 222 may be determined on the basis of the print image data 211 of two different printing marks 221, 222 (for example a printing mark 221 with longitudinal bars and a printing mark 222 with transversal bars). For example, a Delta E value may be determined between the two printing marks 221, 222. This inking difference between the two printing marks 221, 222 may be used as a pitch measure or as a control fault for the adaptation of the composition and/or the quantity of the coating substance 213. Upon a start ramp of the printing system 10 (in which only printing marks 221, 222 are printed), it can thereby already be determined whether an adaptation of the composition and/or quantity of the coating substance 213 is necessary. Furthermore, an automatic adaptation of the composition and/or quantity of the coating substance 213 may be implemented.

For example, if it is detected that the quantity of coating substance 213 is high, a control signal 212 may be sent to the conditioning group 23, via which the conditioning group 23 is induced to change the speed of the raster roller such that less coating substance 213 is transferred to the recording medium 20. On the other hand, if it is detected that the composition of the coating substance 213 is to be adapted, a control signal 212 may be sent to the conditioning group 23, which control signal 212 induces the conditioning group 23 to provide an adapted composition of the coating substance 213 via admixing of active substance carrier fluid, active substance and/or additive substances, and to dispense said adapted composition to the recording medium 20 in a suitable quantity.

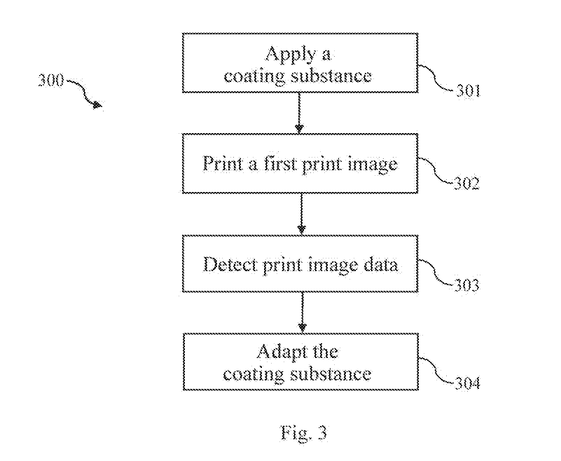

FIG. 3 illustrates a workflow diagram of a method 300 according to an exemplary embodiment. The method 300 is for regulating a property (in particular a composition) and/or a quantity of a coating substance 213 during the operation of a printing system 10. In an exemplary embodiment, the method 300 includes the application 301 of a coating substance 213 onto a recording medium 20 in order to provide a pre-treated recording medium 20. The applied coating substance 213 thereby has a first property (e.g. a first composition). Furthermore, a specific first quantity of the coating substance 213 is applied. The coating substance 213 is applied into the surface of the recording medium 20 in a region 203 in which a first print image should be printed.

In an exemplary embodiment, the method 300 includes the printing 302 of the first print image on the pre-treated recording medium 20 by the printing system 10 (e.g. by a print group 11 of the printing system 10). The first print image is thereby printed on the surface of the recording medium 20 in the region 203 in which the coating substance 213 was applied with the first property (in particular with the first composition) and in the first quantity.

In an exemplary embodiment, the method 300 includes the detection 303 of print image data 211, wherein the print image data 211 indicate information with regard to the first print image. The print image data 211 may be detected with a print image sensor 205. The print image sensor 205 may comprise a camera and/or a spectral photometer, for example. For example, the print image data 211 may thus include image data with regard to the first print image and/or color values with regard to the first print image.

In an exemplary embodiment, the method 300 includes the adaptation 304—on the basis of the print image data 211—of a property (in particular of a composition) and/or of a quantity of the coating substance 213 to be applied onto the recording medium 20 for the printing of the second print image. The second print image thereby follows after the first print image, meaning that the adaptation of the property (in particular of the composition) and/or of the quantity of the coating substance 213 takes place for a second print image which should be printed on a subsequent segment of the recording medium 20 after the first print image.

In an exemplary embodiment, the recording medium 20 may in particular be a web-shaped recording medium 20, and print images may be periodically printed onto the recording medium 20. This may be periodically detected and evaluated by means of the print image sensor 205 in order to periodically adapt the properties (in particular the composition) and/or the quantity of the coating substance 213 applied onto the recording medium 20, and thus in order to increase the quality of the print image or to keep it at a high level.

In this disclosure, a printing system 10 is thus described, wherein the printing system 10 may be configured to print a toner-based—in particular a liquid toner-based—print image onto a recording medium 20. In one or more exemplary embodiments, the printing system 10 comprises a conditioning group 23 that is configured to apply a coating substance 213 onto a recording medium 20, and thus to provide a pre-treated recording medium 20. The coating substance 213 may be used to increase an adhesion of the toner on the surface of the recording medium 20, to improve the electrical properties of the recording medium 20 and/or to increase the absorption capability of the recording medium 20. In an exemplary embodiment, the coating substance 213 may comprise an active substance (polymers, for example) that is configured to increase the adhesion of the print image on the recording medium 20, to alter the electrical properties of the recording medium 20 and/or to increase the absorption capability of the recording medium 20. In an exemplary embodiment, the coating substance 213 may include an active substance carrier fluid (water, for example) that is configured to distribute the active substance on the surface of the recording medium 20.

In an exemplary embodiment, the printing system 10 includes at least one print group 11 that is configured to print a first print image on the pre-treated recording medium 20. In a preferred embodiment, the first print image comprises a first printing mark 221 that has one or more printed bars or stripes in a transport direction 202 of the recording medium 20 through the print group 11. Moreover, the first print image may comprise a second printing mark 222 that has one or more printed bars or stripes transversal to the transport direction 202 of the recording medium 20. Other printing marks 221, 222 may also be used. In particular, the bars or stripes may be discontinuous. Furthermore, a first print image may be used which comprises a first printing mark 221 and a second printing mark 222, wherein the second printing mark 222 corresponds to the first printing mark 221 but is rotated by, for example, 90 degrees.

A print image with a first printing mark 221 and a second printing mark 222 may be particularly efficiently used to adapt a property—in particular a composition—and/or a quantity of the coating substance 213 applied by the conditioning group 23 in order to increase the print quality of the printing system 10.

In an exemplary embodiment, the printing system includes a print image sensor 205 (for example a camera and/or spectral photometer) that is configured to detect print image data 211, wherein the print image data 211 indicate information with regard to the first print image. The print image sensor 205 may be arranged directly after the print group 11.

Alternatively or additionally, the print image sensor 205 may be arranged after a plurality of print groups 11 of the printing system 10. For example, print images with printing marks 221, 222 may be printed on the recording medium 20 by each of the plurality of print groups 11. These print images may then be detected individually by a print image sensor 205 after every single print group 11 and/or together by a print image sensor 205 after the last print group 11. The print images may thus possibly be detected multiple times by a print image sensor 205.

In an exemplary embodiment, the printing system 10 includes a controller 201 that is configured to determine—on the basis of the print image data 211—a property (in particular a composition) and/or a quantity of the coating substance 213 to be applied by the conditioning group 23 (for a future print image). In an exemplary embodiment, the controller 201 is configured to induce the conditioning group 23 to accordingly adapt the property (in particular the composition) and/or the quantity of the coating substance 213 that is to be applied onto the recording medium 20 for the printing of a second print image. The second print image thereby follows after the first print image.

In one or more exemplary embodiments, different properties of the coating substance 213 may be adapted by the conditioning group 23. In particular, the composition of the coating substance 213 may be adapted. Alternatively or additionally, a temperature of the applied coating substance 213 may be varied. Furthermore, a viscosity and/or a surface tension of the coating substance 213 may be varied. Alternatively or additionally, a property of the coating substance 213 may be adapted to the surface of the recording medium 20. For example, the coating substance 213 may be dried (at least partially) before application of the first print image. Alternatively or additionally, a property and/or a quantity of the coating substance 213 may be varied via the manner of application of the coating substance 213. For example, a differentiation may be made between a full-surface or punctiform/digital application in order to alter a property and/or a quantity of the applied coating substance 213.

In one or more exemplary embodiments, the composition of the coating substance 213, which may be adapted by the conditioning group 23, may be differentiated by one or more of, for example: a type of the active substance; a type of the active substance carrier fluid; a proportion of active substance relative to a proportion of active substance carrier fluid; a type of an additive substance; and/or a proportion of the additive substance.

The conditioning group 23 may comprise a raster roller 208, wherein a raster roller 208 typically comprises a plurality of scoop cups that may scoop a defined quantity of coating substance 213. The conditioning group 23 may be configured to modify a rotation speed of the raster roller 208 in order to modify a quantity of the applied coating substance 213. The rotation speed of the raster roller 208 may thereby be modified independently of the travel velocity of the recording medium 20 through the conditioning group 23. For this purpose, a drift may be used between the raster roller 208 and a transfer roller (which typically rotates according to the travel velocity of the recording medium 20) of the conditioning group 23. The quantity of the applied coating substance 213 may be efficiently adapted via an adaptation of the rotation speed of the raster roller 208.

Alternatively or additionally, the conditioning group 23 may comprise a spraying element (for example an inkjet head) for the coating substance 213. The spraying element may be configured to spray different quantities of coating substance 213 onto the recording medium 20. The conditioning group 23 may thus be configured to modify a quantity of coating substance 213 ejected by the spraying element.

In an exemplary embodiment, the adaptation of the quantity of coating substance 213 is particularly reasonable in order to compensate for changing properties of the recording medium 20 within a roll 21 or, respectively, within one or different charges of the recording medium 20 that is used.

In an exemplary embodiment, the conditioning group 23 may comprise a first container 206 with a first coating substance 213 with a first composition and a second container 206 with a second coating substance 213 with a second composition. For example, the first coating substance 213 may have a relatively high proportion of active substance (relative to the active substance carrier fluid). The second coating substance 213 may, for example, comprise a pure active substance carrier fluid in order to dilute the highly concentrated first coating substance 213 as needed. The conditioning group 23 may be configured to vary a composition of the coating substance 213 by changing a mixture of the first coating substance 213 and the second coating substance 213. A composition of the coating substance 213 (in particular the concentration of active substance in the coating substance 213) may thus be efficiently varied.

In an exemplary embodiment, the controller 201 may be configured to determine a model of a controlled system of the printing system 10 (for example by accessing a storage (e.g. memory) of said printing system 10). The controlled system thereby comprises the conditioning group 23 and the print group 11 of the printing system 10. Furthermore, the controller 201 may be configured to determine a value of a control fault on the basis of the print image data 211. Furthermore, the controller 201 may be configured to determine—on the basis of the model of the controlled system and on the basis of the control fault—the property (in particular the composition) and/or the quantity of the coating substance 213 applied by the conditioning group 23 or to be applied by the conditioning group 23. In particular, the property (in particular the composition) and/or the quantity of the coating substance 213 applied or to be applied by the conditioning group 23 may be adapted such that the control fault is reduced. This adaptation of the property and/or the quantity of the coating substance 213 to be applied by the conditioning group for a following print image may thereby take place periodically during the printing operation of the printing system 10.

In an exemplary embodiment, via the detection of the print image data 211, a control loop may thus be provided in order to periodically adapt the property (in particular the composition) and/or the quantity of the coating substance 213. The controller 201 may determine a control fault on the basis of the print image data 211, and the control fault may be used to determine a new property (in particular a new composition) and/or a new quantity as a correcting variable.

In an exemplary embodiment, given use of a print image with a first printing mark 221 and a second printing mar 222, the control fault may be determined on the basis of a comparison of the print image data 211 with regard to the first printing mark 221 and the print image data 211 with regard to the second printing mark 222. For example, it may be assumed as a nominal state (i.e. as a reference variable of the controller) that the first printing mark 221 (rotated by, for example, 90 degrees) corresponds to the second printing mark 222. Discrepancies between the printed first printing mark 221 and the printed second printing mark 222 then lead to the control fault.

The control faults may thereby be based in particular on a color difference (for example a Delta E value) of the print image data 211 with regard to the first printing mark 221 and the print image data 211 with regard to the second printing mark 222. Alternatively, the control fault may be calculated on the basis of a first color value that is determined using the print image data 211 with regard to the first printing mark 211 and on the basis of a second color value that is determined using the print image data 211 with regard to the second printing mark 222. Alternatively or additionally, the control fault may be calculated on the basis of a first inking value (in particular a first optical density) that is determined using the print image data 211 with regard to the first printing mark 221 and on the basis of a second inking value (in particular a second optical density) that is determined using the print image data 211 with regard to the second printing mark 222.

In an exemplary embodiment, the controller 101 may additionally be configured to determine the property (in particular the composition) and/or the quantity of the applied coating substance 203 that was applied onto the pre-treated recording medium 20 in the region of the first print image. The real state may thus be determined with regard to the property (in particular the composition) and/or with regard to the quantity of the coating substance 213 that is used. The property (in particular the composition) and/or the quantity of the coating substance 213 to be applied by the conditioning group 23 for the second print image may then be adapted based on the property (in particular the composition) and/or the quantity of the coating substance 213 applied for the first print image (i.e. based on the real state).

Via the device described in this document, it may be ensured that the applied quantity and/or the properties of the coating substance 213 are always adapted to the current printing situation (for example to the current properties of the recording medium 20), and are thereupon optimized. This may be affected via a control loop. Furthermore, the consumption of coating substance 213 may possibly be reduced. In order to enable a flexible composition of the coating substance 213, the conditioning group 23 may be configured to keep ready a concentrate of primer active substance and to dilute this concentrate flexibly and as needed with a suitable active substance carrier fluid (based on H₂O, for example) in order to provide a coating substance 213 with a matching composition.

Via the adaptation of the pre-treatment with a coating substance 213, even possible fluctuating properties in the print groups 11 of the printing system 10 (for example a fluctuating quantity of toner carrier fluid) may be compensated. Printing marks 221, 222 may be used for the regulation of a property (in particular the composition) and/or the quantity of the coating substance 213. These printing markers 221, 222 may be analogously used for the adjustment of a suitable quantity of toner carrier fluid in the print groups 11, such that the regulation may take place in a resource-efficient manner. Furthermore, a manual changing of the raster roller 208 of the conditioning group 23 for different printing situations may be foregone via the regulation of the composition and/or quantity of the coating substance 213, since a quantity regulation of the coating substance 213 may take place via the rotation speed of the raster roller 208.

### Conclusion

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### Reference List

10 printing system, in particular digital printer

11, 11a-11d print group (front side)

12, 12a-12d print group (back side)

20 recording medium

21 roll (input)

22 take-off unit

23 conditioning group

24 turning unit

25 register unit

26 pulling unit

27 take-up unit

28 roll (output)

30 fixing unit

40 air conditioning module

50 power supply

60 controller

70 fluid management

71 fluid controller

72 reservoir

200 device for adaptation of a property and/or quantity of a coating substance

201 controller

202 transport direction of the recording medium

203 region on the recording medium

205 print image sensor

206 container

207 mixer

208 raster roller

211 print image data

212 control signal

213 coating substance

221, 222 printing mark

300 method to regulate a property and/or a quantity of a coating substance

301, 302, 303, 304 method steps

What is claimed is:

1. A printing system comprising:
a conditioning group that is configured to apply a coating substance onto a recording medium to provide a pre-treated recording medium;
a print group that is configured to print a first print image onto the pre-treated recording medium;
a print image sensor that is configured to detect print image data indicative of information associated with the first print image; and
a controller that is configured to:
determine, based on the print image data, at least one of: a property of the coating substance to be applied by the conditioning group, and a quantity of the coating substance to be applied by the conditioning group; and
induce the conditioning group, based on the determination, to adapt at least one of: the property of the coating substance that is to be applied for the printing of a second print image onto the recording medium, and the quantity of the coating substance that is to be applied for the printing of the second print image onto the recording medium, wherein the second print image is to be printed after a printing of the first print image.

2. The printing system according to claim 1, wherein:
the conditioning group includes a raster roller; and
the conditioning group is configured to modify a rotation speed of the raster roller to vary a quantity of the applied coating substance.

3. The printing system according to claim 1, wherein:
the conditioning group includes a spraying element for the coating substance; and
the conditioning group is configured to vary a quantity of coating substance ejected from the spraying element to vary a quantity of the applied coating substance.

4. The printing system according to claim 1, wherein:
the conditioning group includes a first container with a first coating substance with a first composition and a second container with a second coating substance with a second composition; and
the conditioning group is configured to modify a composition of the coating substance by changing a mixture of the first coating substance and the second coating substance.

5. The printing system according to claim 1, wherein:
the coating substance includes:
an active substance that is configured to modify at least one of: the adhesion of a print image to the recording medium, electrical properties of the recording medium, and an absorption capability of the recording medium; and
an active substance carrier fluid that is configured to distribute the active substance on a surface of the recording medium; and
a composition of the coating substance depends on one or more of:
a type of active substance;
a type of active carrier fluid;
a proportion of the active substance relative to a proportion of the active substance carrier fluid;
a type of additive substance; and
a proportion of the additive substance.

6. The printing system according to claim 1, wherein the controller is configured to:
determine a model of a controlled system of the printing system, the controlled system including a conditioning group and the print group;
determine a value of a control fault based on the print image data; and
determine at least one of the property and the quantity of the coating substance to be applied by the conditioning group based on the model of the controlled system and the control fault.

7. The printing system according to claim 6, wherein:
the first print image includes:
a first printing mark having one or more printed stripes in a transport direction of the recording medium through the print group; and
a second printing mark having one or more printed stripes transversal to the transport direction of the recording medium; and
the control fault is determined based on a comparison of a first print image data of the print image data corresponding to the first printing mark and a second print image data of the print image data corresponding to the second printing mark.

8. The printing system according to claim 7, wherein the control fault is based on one or more of:
a Delta E value of the first print image data associated with the first printing mark and the second print image data associated with the second printing mark;
a first color value determined based on the first print image data associated with the first printing mark;
a second color value determined based on the second print image data associated with the second printing mark;
a first inking value determined based on the first print image data associated with the first printing mark;
a second inking value determined based on the second print image data associated with the second printing mark.

9. The printing system according to claim 8, wherein the first inking value is a first optical density determined based on the first print image data and the second inking value is a second optical density determined based on the second print image data.

10. The printing system according to claim 1, wherein:
the first print image includes:
a first printing mark having one or more printed stripes in a transport direction of the recording medium through the print group; and
a second printing mark having one or more printed stripes transversal to the transport direction of the recording medium.

11. The printing system according to claim 10, wherein the controller is configured to:
compare a first print image data of the print image data corresponding to the first printing mark and a second print image data of the print image data corresponding to the second printing mark; and
induce the conditioning group based on the comparison.

12. The printing system according to claim 1, wherein the controller is configured to:
determine at least one of the property and the quantity of the coating substance having been applied onto the pre-treated recording medium in a region of the first print image; and
determine at least one of a property and a quantity of the coating substance to be applied by the conditioning group onto the pre-treated recording medium for the second print image based on at least one of the property and the quantity of the coating substance applied for the first print image.

13. The printing system according to claim 1, wherein the controller is configured to periodically adapt at least one of the property and the quantity of the coating substance to be applied by the conditioning group for a subsequent print image.

14. A method to regulate at least one of a property and a quantity of a coating substance during operation of a printing system, the method comprising:
applying a coating substance onto a recording medium to provide a pre-treated recording medium;
printing a first print image onto the pre-treated recording medium by the printing system;
detecting print image data that is indicative of information associated with the first print image; and
adapting, based on the print image data, at least one of a property and a quantity of the coating substance to be applied onto the recording medium for the printing of a second print image to be printed on the pre-treated recording medium, the second print image being printed after the first print image has been printing.

15. A printing system comprising:
a conditioning group that is configured to apply a coating substance onto a recording medium to provide a first pre-treated region on the recording medium;
a print group that is configured to print a first print image onto the first pre-treated region of the recording medium;
a print image sensor that is configured to detect print image data associated with the first print image having been printed on the first pre-treated region; and
a controller that is configured to:
determine, based on the print image data, a quantity of the coating substance and a composition of the coating substance having been applied in the first pre-treated region of the recording medium;
adjust, based on the determination, at least one of: the quantity of the coating substance to be applied to the recording medium to provide a second pre-treated region on the recording medium, and the composition of the coating substance to be applied to the recording medium;
control the conditioning group to apply the coating substance to recording medium to generate the second pre-treated region, the second pre-treated region being generated with at least one of the adjusted quantity of the coating substance and the adjusted composition of the coating substance; and
control the print group to print a second print image onto the second pre-treated region.
